(19) United States
(12) Patent Application Publication
(10) Pub. No.: US 2005/0219722 A1
(43) Pub. Date: Oct. 6, 2005

(54) Clutch assembly for breakaway mirror

(76) Inventors: Craig Watrous, Corry, PA (US); Steve Cofer, Ashville, NY (US); Kurt Schwab, North Warren, PA (US); Nicholas Podgaietsky, Tile Hill (GB)

Correspondence Address: The Bilicki Law Firm, P.C.;Furniture Mart Building, Suite 1000, 111 West Second Street, Jamestown, NY, 14701, US

(21) Appl. No.: 11/034,686

(22) Filed: Jan. 13, 2005

Related U.S. Application Data
(60) Provisional application No. 60/536,031, filed on Jan. 13, 2004.

(51) Int. Cl. B23P 19/04

(52) U.S. Cl. 359/841

(57) ABSTRACT

A device comprised of: a support arm; a mirror head functionally engaging the support arm along the support arm; a lower mounting assembly affixed to a vehicle and adapted to receive the support arm at a first end and comprised of a cup with a tapered inner surface; an upper mounting assembly, also affixed to the vehicle and engaging the support arm at a second end; and a mirror clutch assembly disposed substantially with the lower mounting assembly cup and comprised of: an upper cam with a plurality of detents on its lower surface; a lower cam located below and functionally engaging the upper cam and having a plurality recesses corresponding with the upper cam detents; a biasing member below the lower cam and exerting a biasing force on the lower cam; a taper compensation mechanism, to account for the tapered inner surface of the cup; and an upper cam locking mechanism for locking the upper cam in position relative to the support arm, such that upon exertion of an external force on the device, the support arm and upper cam axially rotate and the lower cam vertically translates to at least partially absorb the external force.

### CROSS-REFERENCE TO RELATED APPLICATIONS

This application claims priority under 35 U.S.C. §119(e) to U.S. provisional application Ser. No. 60/536,031 filed on Jan. 13, 2004, which is incorporated herein in its entirety.

### FIELD OF THE INVENTION

The subject invention relates generally to an external rear-view mirror mounted on a heavy-duty motor vehicle. More specifically, the invention relates to a clutch assembly for an external rear-view mirror, in which the mirror comprises a mirror head mounted on a rotatable tubular support arm such that the mirror head can move between an in-use driving or deployed position to a second position such as an intermediate or park position.

### BRIEF DESCRIPTION OF THE DRAWINGS

FIG. 1 is an assembly view of a mirror-operating mechanism according to one embodiment of the present invention.

FIG. 2A is an exploded perspective view of a mirror-operating mechanism according to one embodiment of the present invention.

FIG. 2B is an assembly view of a rear view mirror assembly according to one embodiment of the present invention.

FIG. 3 illustrates a top, partial perspective view of the lower mounting assembly.

FIG. 4A illustrates a partial, cross-sectional view of a mirror-operating mechanism according to one embodiment of the invention with the support arm removed.

FIG. 4B illustrates a partial, cross-sectional view of a mirror-operating mechanism according to one embodiment of the invention with the support in place.

FIGS. 5A, 5B, and 5C illustrate a top plan view, a bottom plan view, and a bottom perspective view, respectively, of the upper cam in a clutch assembly according to one embodiment of the invention.

FIGS. 6A, 6B, and 6C illustrate a top plan view, a bottom plan view, and an inside view, respectively, of the lower cam elements in a clutch assembly according to one embodiment of the invention in which three lower cam elements are used.

FIG. 7 shows an outside view of one embodiment of the upper and lower cams and the inclined flanks of the detents of the upper cam and the corresponding inclined flanks of the recesses of the lower cam.

FIGS. 8A and 8B show the vertical translation of the lower cam as the upper cam is rotated.

FIGS. 9A and 9B illustrate alternate embodiments of a taper compensation mechanism according to the invention.

### DESCRIPTION OF EMBODIMENTS OF THE INVENTION

Many heavy duty and commercial vehicles are equipped with relatively large side-mounted rear view mirrors that comprise a mirror head mounted on a tubular, C-loop support arm. The term “C-loop” is used because the tubular support arm is bent at substantially right angles to resemble the shape of a “C”. This provides a first vertical length extending downward, which is secured to the vehicle body side by means of a lower mounting assembly, and a second, vertical length extending upward which is attached to the mirror head. It is desirable to mount the C-loop support arm to the lower mounting assembly such that the mirror assembly can be folded inwardly toward the vehicle body side when the mirror head is displaced by an external force or to reduce the overall width of the vehicle when traveling through narrow passageways.

The clutch mechanism according to the subject invention will be described in relation to its application as an operating mechanism in a side-mounted rear view mirror used on heavy-duty commercial vehicles, such as trucks or tractor-trailers. However, it should be realized that the clutch assembly as described herein may be used with mirrors on other motor vehicles, or with other devices not necessarily mirrors, and therefore the invention should not be restricted to this specific application described.

For the purpose of promoting an understanding of the present invention, references are made in the text hereof to embodiments of a mirror clutch assembly, some of which are illustrated in the drawings. It is nevertheless understood that no limitations to the scope of the invention are thereby intended. One of ordinary skill in the art will readily appreciate that modifications such as those involving the shape of the tubular support arm, number of detents and corresponding recesses, materials selected, or biasing force of the biasing member, do not depart from the spirit and scope of the present invention. Some of these possible modifications are mentioned in the following description. Furthermore, in the embodiments depicted, like reference numerals refer to identical structural elements in the various drawings.

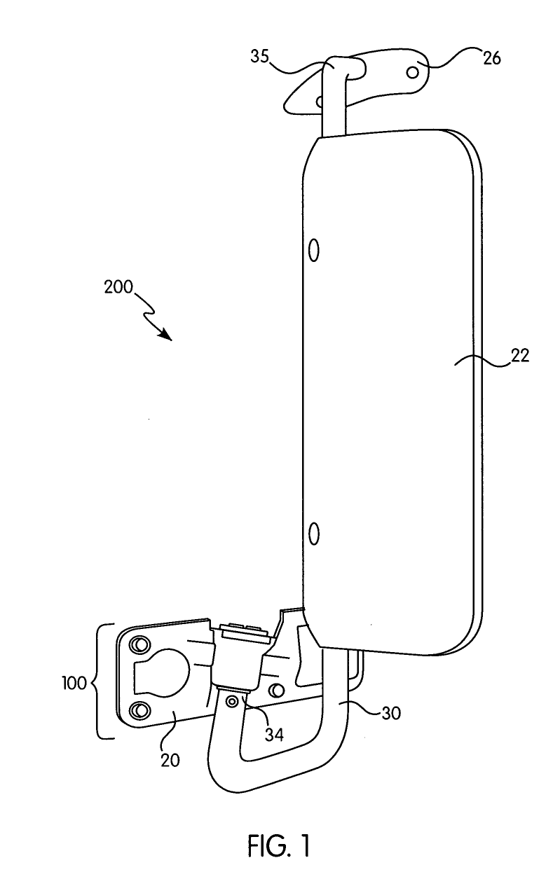

FIG. 1 shows a perspective view of one embodiment of a mirror assembly according to the invention, generally indicated by the reference number 200. In this embodiment, support arm 30 operatively engages with lower mounting assembly 20 at first end 34 and upper mounting assembly 26 at second end 35 to support mirror head 22. Lower mounting assembly 20 and upper mounting assembly 26 function to secure mirror head 22 to the body side of a heavy-duty commercial vehicle, such as a truck or tractor-trailer (not shown). However, one of ordinary skill in the art will recognize that mirror assembly 200 could be mounted to any vehicle.

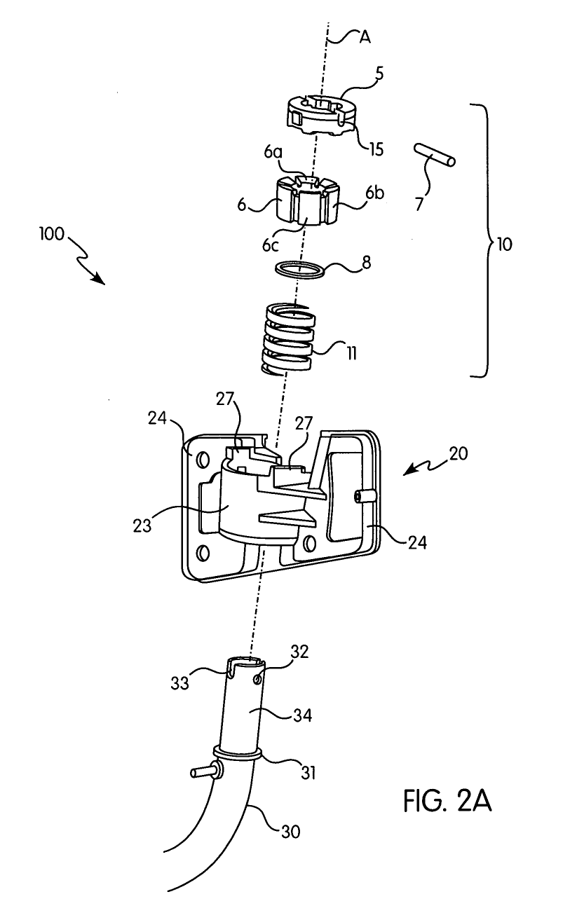

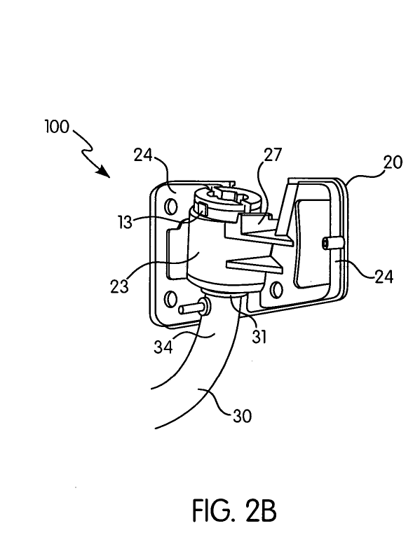

FIG. 2A shows an exploded perspective view of one embodiment of a mirror operating mechanism according to the invention, generally indicated by the reference number 100. Specifically, FIG. 2A shows one embodiment of mirror-operating mechanism 100 comprised of a clutch assembly, generally indicated by the number 10, as well as lower mounting assembly 20 and a tubular, C-loop support arm 30 (partially shown). Lower mounting assembly 20, in this embodiment, comprises cup 23 and mounting brackets 24. Referring further to FIG. 2A, clutch assembly 10 is shown comprised, in this embodiment, of upper cam 5, lower cam 6, tube washer 8, and biasing member 11, all generally symmetrical about axis A, as well as dowel pin 7.

FIG. 2B illustrates an assembly view of mirror-operating mechanism 100 of FIG. 2A. When mirror-operating mechanism 100 is assembled, both support arm 30 and clutch assembly 10 are operatively disposed substantially within cup 23 of lower mounting assembly 20, as further described herein. As shown in the embodiment of FIG. 2A, pinholes 32 and retaining slots 33 are formed at first end 34 of support arm 30. Moreover, annular flange 31 is circumferential and integral to support arm 30 to support and properly position support arm 30 relative to lower mounting assembly 20.

As seen in FIG. 2B, when first end 34 of support arm 30 is inserted into the bottom of cup 23, annular flange 31 supports cup 23 and allows cup 23 to maintain its position on support arm 30. In this embodiment, the individual elements of mirror assembly 200, including but not limited to clutch assembly 10, are made of zinc. However, in alternate embodiments, the individual elements may be made of aluminum or other suitable durable material (i.e. plastic). Moreover, in this embodiment, tube washer 8 is a stamped part, while lower mounting assembly 20, support arm 30, biasing member 11, dowel pin 7, lower cam 6 and upper cam 5 are die cast parts (all visible in FIG. 2A). However, one of ordinary skill in the art will readily appreciate that each of these parts can also be molded, or combination of components in which some are molded and some are die cast.

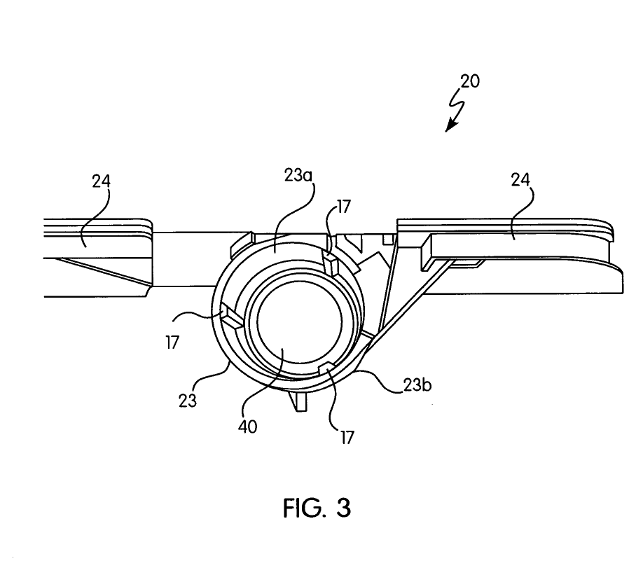

FIG. 3 illustrates a top, partial perspective view of lower mounting assembly 20. As illustrated in FIG. 3, cup 23 has inside surface 23a and outside surface 23b. Furthermore, the top end of cup 23 is open and the bottom end of cup 23 has entry hole 40 that allows the support arm (not shown) to be inserted and operatively engage lower mounting assembly 20. As described supra, lower mounting assembly 20, including cup 23, can be either molded or die-cast and is made of zinc, or other suitable durable material. Accordingly, due to the inherent draft angle of a molded or die-cast part, inside surface 23a is drafted and thus tapered to allow lower mounting assembly 20 to be removed from the tool on which it is formed, such that the diameter of inside surface 23a at the top of cup 23 is greater than the diameter of inside surface 23a at the bottom of cup 23. One of ordinary skill in the art will readily appreciate that the draft angle of a molded or die cast part, such as cup 23, is substantially one (1) to three (3) degrees, relative to the vertical axis of symmetry.

According to one embodiment of the instant invention, a plurality of guide ribs 17 are formed on inside surface 23a of cup 23. More specifically, in the embodiment shown in FIG. 3, three (3) guide ribs 17 are formed integral with inside surface 23a. Each of guide ribs 17 extends laterally downward from the top end of cup 23 toward the bottom end of cup 23. As can also be seen, guide ribs 17 have inclined flanks. As will be described in more detail infra, the flanks of guide ribs 17 are slightly inclined to correspond with the guide slots of each lower cam element (not shown). Moreover, it can be seen that, as with inside surface 23a, each guide rib 17 is tapered to allow lower mounting assembly 20 to be removed from the tool on which it is formed. That is, each guide rib 17 is wider at the top end of cup 23 and progressively narrows as each of guide ribs 17 extends laterally downward toward the bottom end of cup 23. Mounting brackets 24 are also visible in FIG. 3.

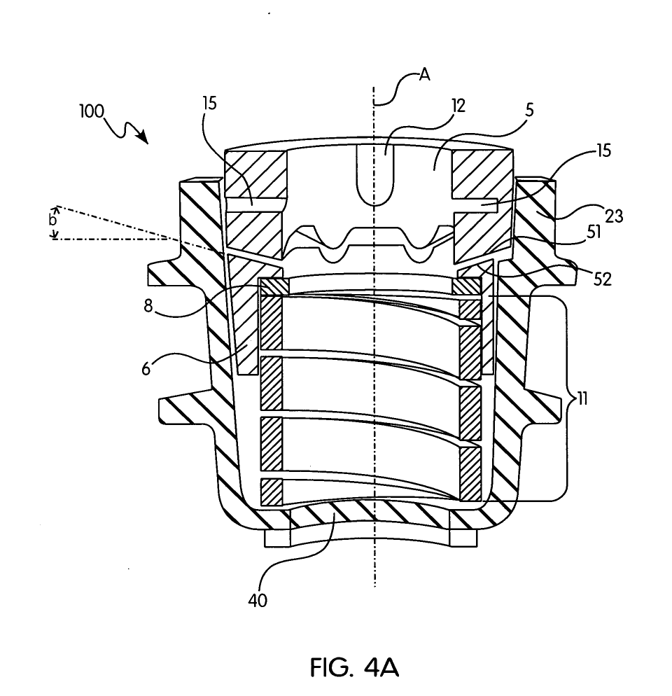

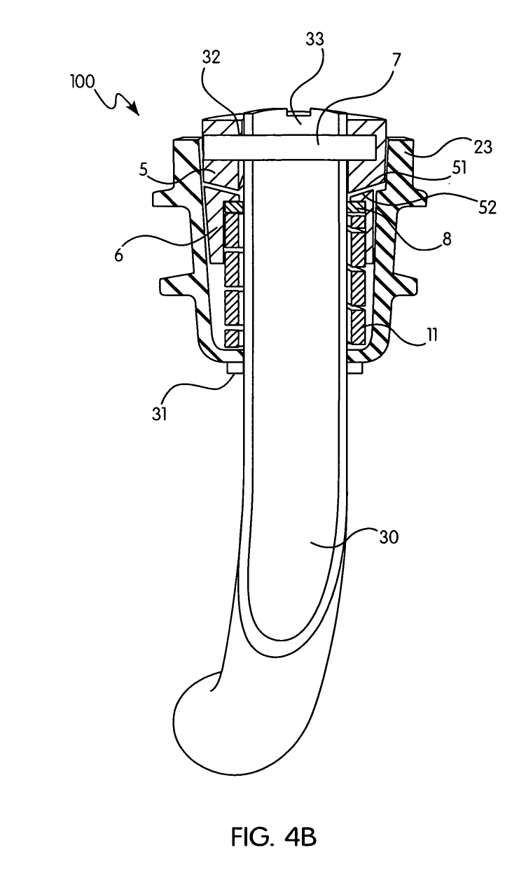

FIGS. 4A and 4B illustrate partial, cross sectional views of mirror-operating mechanism 100. In FIG. 4A, the support arm has been removed. In FIG. 4B, support arm 30 is in place. In both figures, only cup 23 of the lower mounting assembly is shown. Referring to FIG. 4A, upper cam 5 is shown to comprise aperture 15 for receiving the dowel pin (not shown). As shown in FIG. 4B, dowel pin 7 rests within aperture 15 of upper cam 5 and through two pin holes 32 of support arm 30. Dowel pin 7 locks upper cam 5 in place relative to support arm 30 and mirror head 22. The use of dowel pin 7 and pin holes 32 of support arm 30 are one embodiment of an upper cam locking mechanism. However, one of ordinary skill in the art will recognize that this is a non-limiting example and that other permanent or non-permanent upper cam locking mechanisms could be employed, for example, but not limited to, welding, a cotter pin or key, an epoxy, splines, combinations thereof, and any other mechanism or device such that the upper cam locking mechanism is able to resist the rotational torque as well as the biasing force created by biasing member 11.

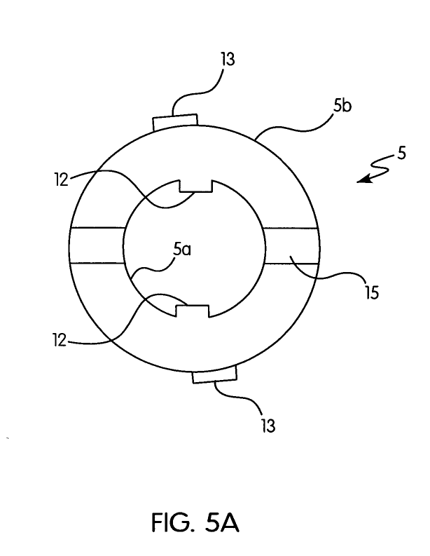

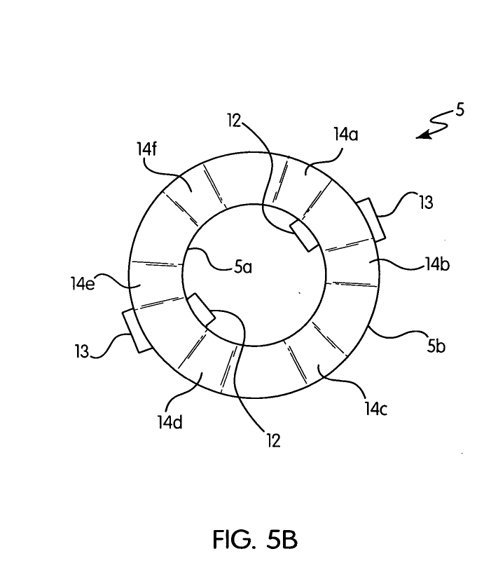

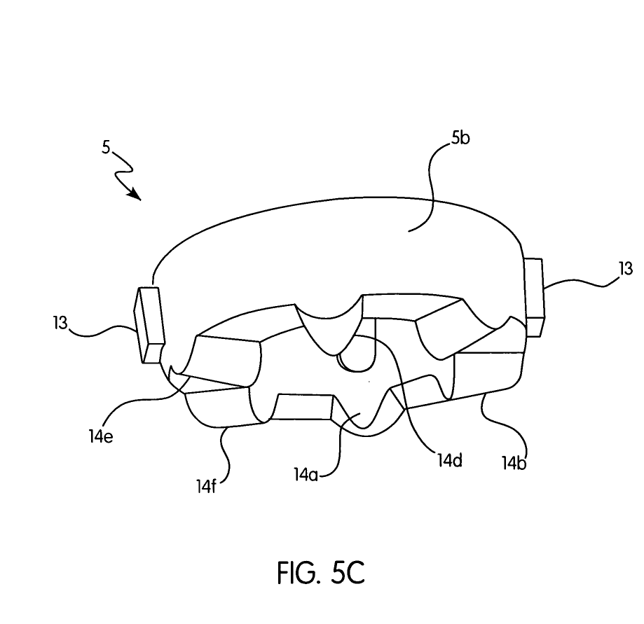

FIGS. 5A, 5B, and 5C illustrate a top plan view, a bottom plan view, and a bottom perspective view of one embodiment of upper cam 5, respectively. As can be seen in FIGS. 5A-5B, a plurality of inner ears 12 are formed on inner surface 5a of this embodiment of upper cam 5. More specifically, in this embodiment, upper cam 5 has two (2) inner ears 12. However, in alternate embodiments (not shown), upper cam 5 may have none, one, or more than two ears 12. As is visible in FIG. 2A, support arm 30 has retaining slots 33 that correspond with ears 12 of upper cam 5. This engagement, along with dowel pin 7, fix the position of upper cam 5 to support arm 30 and allow a rotational force R to be translated to clutch assembly 10 via dowel pin 7 and inner ears 12 of upper cam 5. This combination of inner ears 12, retaining slots 33, and dowel pin 7 are one alternate embodiment of the upper cam locking mechanism. However, inner ears 12 are not necessary elements, and the upper cam locking mechanism could be just dowel 7 and aperture 15.

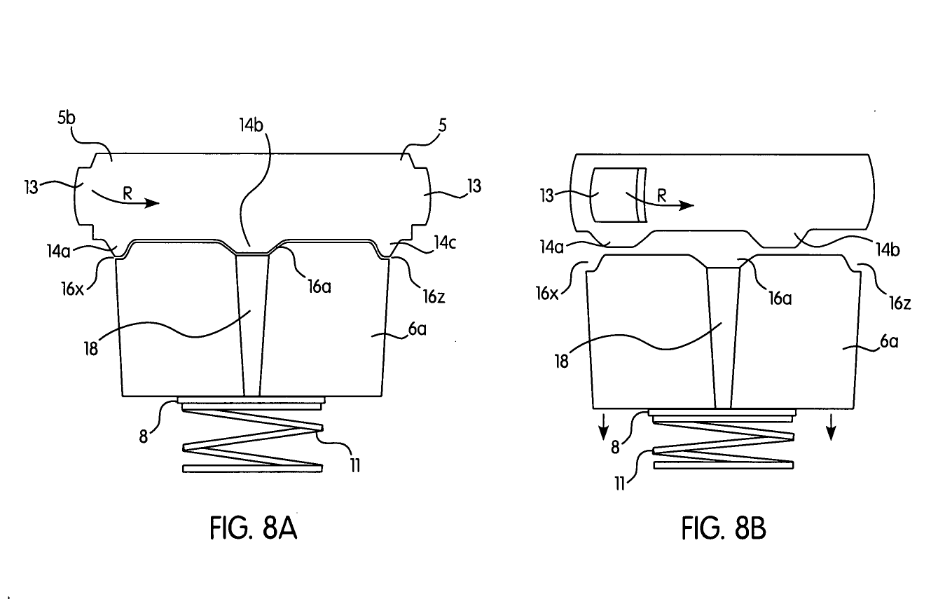

As can further be seen in FIGS. 5A, 5B, and 5C, in the embodiment shown, upper cam 5 is further comprised of stops 13 on outside surface 5b. To achieve a more uniform distribution of the occurring forces, a plurality of stops 13 are provided. Upon rotation of upper cam 5, stops 13 engage tabs 27 on lower mounting assembly 20 (visible in FIGS. 2A and 2B) to prevent mirror assembly 200 from being rotated beyond a threshold point or degree and contacting the vehicle door window when mirror assembly 200 is in a collapsed position. In the embodiment shown in FIGS. 5A, 5B, and 5C, two (2) stops 13 are utilized. However, in alternate embodiments, stops 13 are not necessary, as the rotation of upper cam 5 will cease when detents 14 fall back into the adjacent recesses 16a-c,x-z of lower cam 6 (see FIG. 8B and description infra). Referring to FIGS. 5B and 5C, upper cam 5 also comprises a plurality of detents 14a-f on the bottom surface. More specifically, in this embodiment, upper cam 5 has six (6) detents 14a-f. FIG. 5C shows a bottom perspective view of upper cam 5 in which stops 13 and detents 14a-f can all be further appreciated.

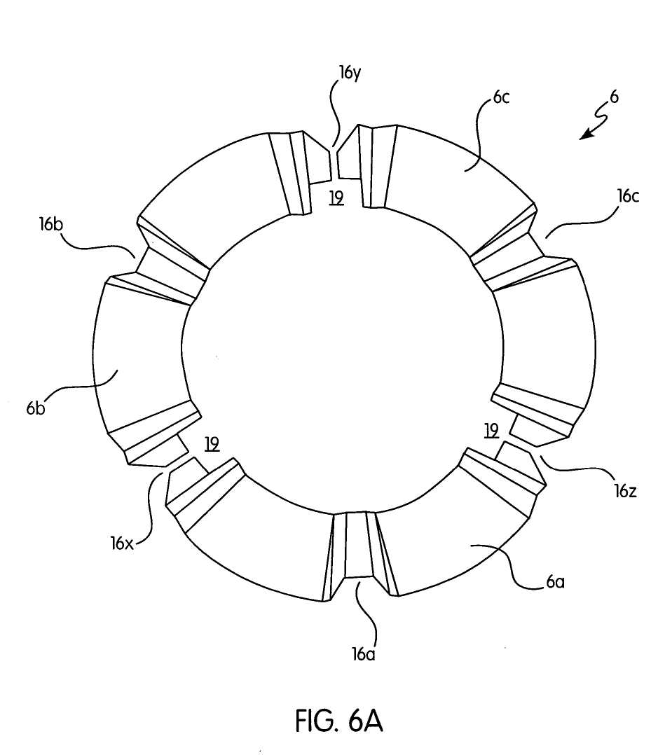

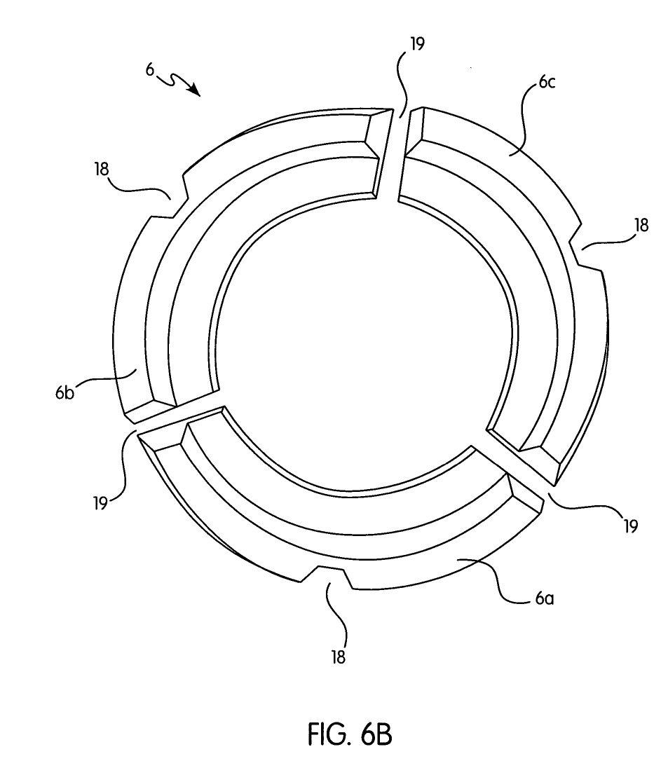

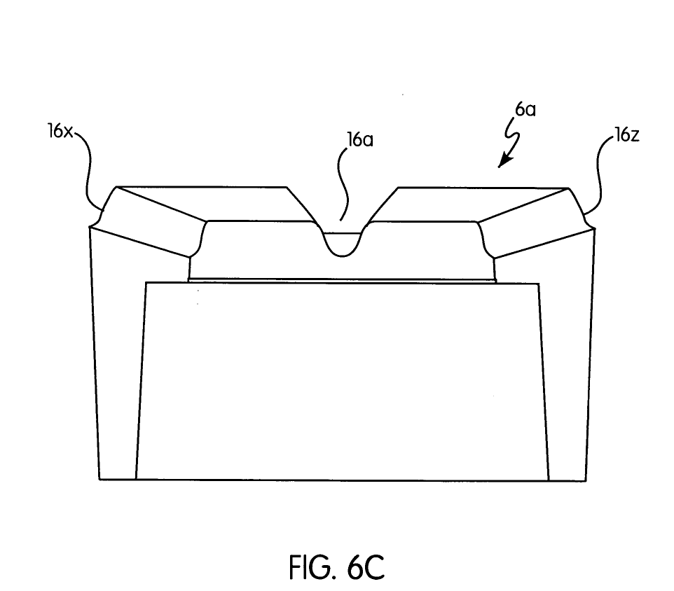

FIGS. 6A, 6B, and 6C illustrate a top plan view, a bottom plan view, and a side view of lower cam 6, respectively. As can be seen in FIGS. 6A-B, in this embodiment, lower cam 6 is divided into three (3), identical lower cam elements 6a-c with gaps 19 therebetween. This allows lower cam 6 to expand and contract radially upon vertical translation within cup 23a, as discussed in greater detail infra. In addition, lower cam 6 is shown to comprise a plurality of recesses 16a-c,x-z that correspond to the plurality of detents 14 of upper cam 5. Specifically, in this embodiment, lower cam 6 has six (6) recesses 16a-c,x-z, each corresponding to one of the six (6) detents 14 of upper cam 5, three of which (16a-c) are generally centrally located on the top surface of each cam element 6a-c, and three of which (16x-z) are located at the junction between each cam element 6a-c, i.e., approximately a half recess 16x-z at each end of cam element 6a-c. In alternate embodiments, however, lower cam 6 may have any number of recesses so long as each corresponds to one of the detents of the upper cam. For example, in alternate embodiments in which lower cam 6 has six (6) recesses 16a-c,x-z, upper cam 5 can have two (2), three (3), or four (4) detents 14. In another non-limiting example, lower cam 6 has four (4) recesses 16 and upper cam 5 can have two (2) or four (4) detents 14.

For purposes of this disclosure, breakaway force F is defined as the amount of energy it takes to displace support arm 30. One of ordinary skill in the art will readily appreciate that this breakaway force F is equivalent to the force required to disengage detents 14a-f of upper cam 5 from recesses 16a-c,x-z of lower cam 6. For the embodiment shown here, a suitable breakaway force F is substantially in the range of 50-90 ft/lbs of torque. However, one of ordinary skill in the art will readily appreciate that F may be in a different range depending on the specific force required for the particular mirror assembly 200, and mirror-operating mechanism 100 can be constructed so that the breakaway force F is at any ft/lbs range.

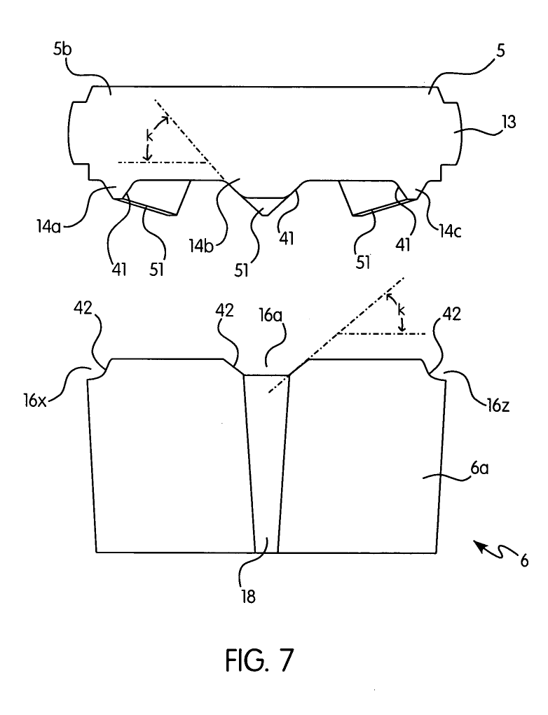

FIG. 7 is an outside view of one embodiment of upper cam 5 and multi-pieced lower cam 6 relative to one another. As shown in FIG. 7, detents 14a-c have inclined flanks 41 and recesses 16a,x,y have inclined flanks 42 so that disengagement between upper cam 5 and lower cam 6 can be performed in a sliding manner. In the embodiment shown here, the angle of inclination k in detent flanks 41 and recess flanks 42 is approximately 40-50 degrees. However, the angle of inclination can be changed to affect the breakaway force F.

As can be seen in FIGS. 4A, 4B, and 7, lower face 51 of upper cam 5 is beveled in a radial direction relative to vertical axis of symmetry A to push lower cam 6, with corresponding beveled surface 52, out radially so that as lower cam 6 vertically translates, it maintains surface contact with inside surface 23a of cup 23 to engage the lower cam anti-rotation mechanism (discussed infra) and prevent lower cam 6 from rotating. In order to do so, because of the tapered inside surface 23a of cup 23, a taper compensation mechanism, i.e., means for compensating for the tapering of cup 23, is required. In the embodiment of the taper compensation mechanism shown here, the bevel on upper cam 5 is up 15 degrees from horizontal. As can be seen in FIGS. 4A and 4B, upper face 52 of lower cam 6 is also beveled to “mesh” with the corresponding beveled lower face 51 of upper cam 5. Accordingly, in this embodiment, the degree to which the bevel, b, on upper face 52 of lower cam 6 is down 15 degrees from horizontal. In alternate embodiments, however, the slope of the bevel on upper cam 5 and the corresponding bevel on lower cam 6 can be in a range of about 5 to 40 degrees depending on the desired breakaway force F.

In one embodiment, as can be seen in FIGS. 6A and 6B, that lower cam 6 is constructed of multiple lower cam elements 6a-c, with gaps 19 therebetween, allows lower cam 6 to vertically translate, such that, as compared to when upper cam is in an upper position within cup 23, gaps 19 are smaller when in the lowermost position within cup 23. That is, because lower cam 6 is in a plurality of parts, the circumference of lower cam 6 can change and compensate for the taper in cup 23.

FIGS. 8A and 8B show the effect that, in operation, a rotational force R exerted on support arm (not shown) and upper cam 5 (which are fixedly connected via upper cam locking mechanism) when mirror head 22 encounters an external force. In the embodiment shown and described herein, the rotational force R is translated to upper cam 5 via the upper cam locking mechanism, such that rotational force R rotates upper cam 5. In the embodiment of the upper cam locking mechanism shown in FIG. 1, in which a suitable breakaway force F is substantially in the range of 50-90 ft/lbs, use of dowel pin 7 alone to translate rotational force R deforms pinholes 32 that house dowel pin 7. Support arm 30 has retaining slots 33 and inner ears 12 of upper cam 5 operatively engage retaining slots 33. In this way, inner ears 12 prevent holes 32 from deforming when rotational force R is exerted by distributing the load between inner ears 12 and dowel pin 7, such that upper cam 5 rotates along with support arm 30. However, one of ordinary skill in the art will readily appreciate that in an alternate embodiment, if the breakaway force F is suitably low, rotational force R can be translated to upper cam 5 via dowel pin 7 alone and inner ears 12 are not necessary and need not be present.

Returning again to FIGS. 8A and 8B, once rotational force R is translated to upper cam 5 and upper cam 5 begins to rotate, lower cam 6 does not move rotationally because the guide slots 18 on the outer surface of lower cam 6 engage the guide ribs on the inside of cup (not shown), or through use of another lower cam anti-rotation mechanism. This engagement, along with the detent 14a-f and recess 16a-c,x-z construction, prevents lower cam 6 from rotating, allowing rotational force R to be translated to vertical force V on lower cam 6.

As upper cam 5 rotates, detents 14a-f leave their corresponding recesses 16a-c,x-z and push down on the uppermost surface of lower cam element 6a, causing cam element 6a to vertically translate. Thus, the rotational force R of upper cam 5 is converted to vertical force V on lower cam 6. The vertical force V on lower cam 6 then compresses biasing member 11. The appropriate biasing force of biasing member 11 is an important factor. In the embodiment shown here, biasing member 11 is a clutch spring has a biasing force of approximately 500 lbs. Biasing member could also be fluid pressure, a hydraulic device, an elastomeric material such as a thermoplastic elastomer, rubber, and combinations thereof. As upper cam further rotates, detents 14a-f will then slip into the next recess 16a-c,x-z, and lower cam 6 will rise to meet upper cam 5.

However, lower cam 6 does not move straight up and down because it also moves inwardly in order to travel along the tapered inner surface of the cup (not shown). The distance traveled by lower cam 6 radially is very minimal and is dependent on the draft angle of cup 23, i.e., the degree to which inside surface 23a of cup 23 is tapered. Upper cam 5 has no vertical movement at all; solely rotational. In the embodiment shown, tube washer 8 functions to improve performance of clutch assembly 10 by providing a flat surface on top of biasing member 11. This in turn allows lower cam 6 to sit flat on biasing member 11. However, in alternate embodiments, washer 8 is not required and need not be present.

In this embodiment, lower cam 6 is split and rides up and down slope of cup 23 along guide ribs 17, as can be seen in FIG. 3. Although the embodiment here shows lower cam 6 in three (3) pieces, in alternate embodiments lower cam can be in two pieces, or four, five, etc. pieces instead of three. The presence of the bevel transmits the biasing force and keeps lower cam 6 tight along tapered inner surface 23a of cup 23 in lower mounting assembly 20.

As can be seen in FIGS. 6B and 7, in one embodiment, each lower cam element 6a-c has guide slot 18 for preventing lower cam 6 from rotating. Use of guide ribs 17 on inside surface 23a of cup 23 and guide slots 18 on each cam element 6a-c is only one embodiment of a lower cam anti-rotation mechanism.

Other examples of the lower cam anti-rotation mechanism are to put some or all of guide ribs 17 between each cam element 6a-c rather than along each lower cam element 6a-c, to have guide ribs only run partially along the length of inside surface 23a of cup 23, to reverse the positioning of guide ribs 17 and guide slots 18, such that guide slots are on inside surface 23a of cup 23 and guide ribs are on lower cam elements 6a-c, or to use a combination thereof. In yet another embodiment of the lower cam anti-rotation mechanism, inside surface 23a cup 23 is constructed with a plurality of guide ribs and a plurality of guide slots, and each lower cam element 6a-c with a guide rib, such that each guide rib of each lower cam element 6a-c corresponds with a guide slot on inside surface 23a of cup 23 and each guide rib of cup 23 corresponds with the gaps between each lower cam element 6a-c; that is, a combination of the previous two embodiments of the lower cam anti-rotation mechanism.

In the embodiment shown, there are six detents 14a-f and corresponding recesses 16a-c,x-z. A plurality of detents 14 and corresponding recesses 16 is required to maintain balance (i.e., one detent and corresponding recess would not operate properly because lower cam 6 would be unbalanced). However, in alternate embodiments, mirror-operating mechanism could be constructed with two, three, four, or five detents 14 and corresponding recesses 16 generally equally spaced around upper cam 5 and lower cam 6, respectively. If varying number of detents and recesses are employed, other factors would need to be adjusted, such as the biasing force of biasing member 11, for specific desired breakaway force F ranges.

The distance between detents 14 (and recesses 16) is determined by how many detents 14 are present in upper cam 5. The more detents 14 present, the higher the breakaway force required to displace support arm 20. With three detents 14, biasing member 11 would need to have increase the biasing force in order to meet the same breakaway force. This, in turn, results in a stiffer biasing member 11. With more detents 14, the load exerted on each detent 14 is more evenly distributed and detents 14 do not wear as quickly. Other ways to adjust the breakway force F, other than by using a stiffer or more flexible biasing member 11 or change the number of detents 14, is to change the angle of flanks 51, 41 or height of detents 14 and the corresponding recesses 16.

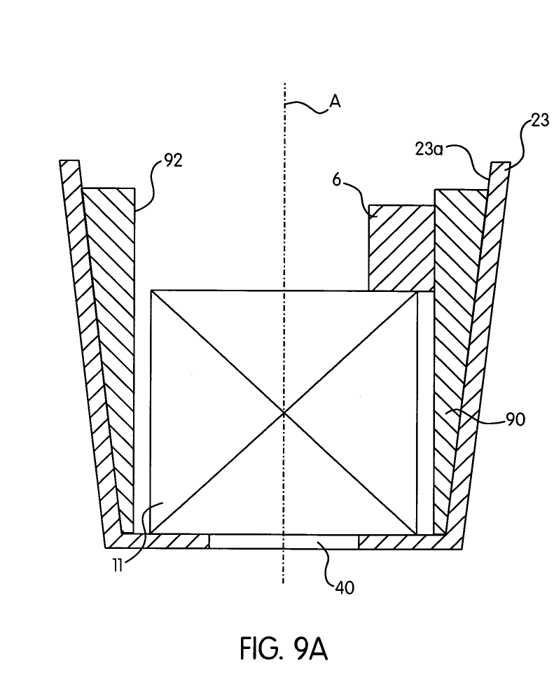

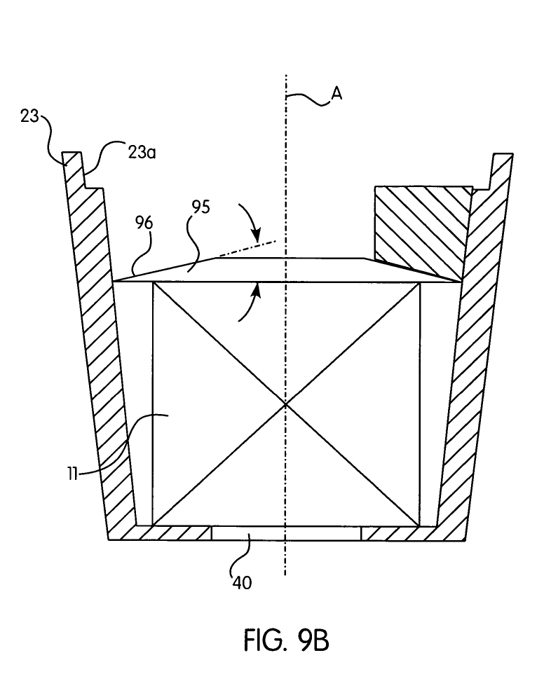

FIG. 9A shows an alternate embodiment of the taper compensation mechanism, in which a one-piece lower cam 6 can be used. In this embodiment, an additional generally cylindrical straightening piece 90 is operatively disposed in cup 23 along the tapered inside surface 23a to create a vertical inner surface 92, perpendicular to the bottom surface. Lower cam 6 would then not have to be able to compensate for the tapering of cup 23, and could be constructed of one piece or multiple pieces. The beveled surfaces of the upper cam (not shown) and lower cam 6 would also not be necessary, but could still be employed to ensure that lower cam 6 maintains contact with vertical inner surface 92 of straightening piece 90. Because it is desired that lower cam 6 be limited to only vertical translation, the mirror clutch-operating mechanism would still require a lower cam anti-rotation mechanism, as described supra. In addition, straightening piece 90 must also be prevented from rotating. Straightening piece 90 could be permanently adhered to cup 23, by means identical or similar to the lower cam anti-rotation mechanism or the upper cam locking mechanism described supra, by welding, by use of an epoxy, external teeth, splines, set screws, press fit, combinations thereof, or any means sufficient for preventing rotation of straightening piece 90.

FIG. 9B illustrates yet another embodiment of a taper compensation mechanism, in which generally cylindrical wedged cap 95 with beveled upper surface 96 is operatively disposed on biasing member 11. In this embodiment, the clutch assembly would still have a multi-piece lower cam 6 but rather than a beveled lower surface on the upper cam (not shown) and on the upper surface of lower cam 6 to push lower cam 6 radially outward, beveled upper surface 95 pushes lower cam 6 out radially via angled sides 96. In this embodiment, the slope of beveled upper surface 96 of wedged cap 95 is functionally equivalent to the bevel in the upper cam, described supra.

In still another embodiment of a taper compensation mechanism, secondary machining is used to remove the tapering from inside surface 23a of cup 23, such that the thickness of cup 23 at the lowermost surface is thinner than at the uppermost surface. The result is substantially right angles between the bottom and inside surface 23a of cup 23, i.e., inside surface 23a is substantially perpendicular to the bottom surface.

in still another alternate embodiment of a taper compensation mechanism, in order to ensure that lower cam 6 maintains contact with inside surface 23a of cup 23 and that lower cam 6 engages the lower cam anti-rotation mechanism, a tapered sleeve (not shown) is placed over first end 34 of support arm 30, over which lower cam 6 rides, pushing the plurality of lower cam elements 6a-c outward.

Although, for convenience, the invention has been described primarily with reference to several specific embodiments, it will be apparent to those of ordinary skill in the art that the valve and the components thereof can be modified without departing from the spirit and scope of the invention as claimed.

1. A device comprised of:
a support arm with a first end and a second end;
a mirror head adapted to functionally engage said support arm along said support arm;
a lower mounting assembly adapted to be affixed to a vehicle and to functionally engage said first end of said support arm, wherein said lower mounting assembly is comprised of a cup with a bottom surface and a tapered inner surface, said bottom surface adapted to receive said support arm;
an upper mounting assembly, adapted to be affixed to said vehicle and adapted to functionally engage said second end of said support arm;
a mirror clutch assembly disposed substantially with said cup of said lower mounting assembly and comprised of:
a generally cylindrical upper cam with an upper surface, a lower surface, a inner surface, and an outer surface, wherein said lower surface of said upper cam is comprised of a plurality of detents;
a generally cylindrical lower cam with an upper surface, a lower surface, an inner surface and an outer surface, located below and functionally engaging said upper cam, wherein said lower cam is further comprised of a plurality recesses for receiving said plurality of detents of said upper cam;
a biasing member functionally engaging said lower surface of said lower cam and for exerting a biasing force on said lower cam toward said upper cam; and
an upper cam locking mechanism for locking said upper cam in position relative to said support arm;
a taper compensation mechanism, to account for said tapered inner surface of said cup of said lower mounting assembly; and
a lower cam anti-rotation mechanism to restrict said lower cam to only vertical translation, such that upon exertion of an external force on said device, said support arm and said upper cam axially rotate and said lower cam vertically translates, compressing said biasing member to at least partially absorb said external force and prevent/minimize damage to said vehicle and said mirror head.

2. The device of claim 1, wherein said support arm, said mirror head, said lower mounting assembly, said upper mounting assembly, said upper cam, said lower cam, and said clutch spring are each made of a material selected from a group comprised of zinc, aluminum, plastic, and combinations thereof.

3. The device of claim 1, wherein said first end of said support arm is further comprised of an annular flange for supporting said lower mounting assembly.

4. The device of claim 1, wherein said biasing member is selected from a group comprised of a clutch spring, a fluid, a hydraulic device, an elastomeric material, a rubber, and combinations thereof.

5. The device of claim 1, wherein said mirror clutch assembly is further comprised of a tube washer disposed between said lower surface of said lower cam and said biasing member to provide a flat surface on top of said biasing member to evenly distribute said biasing force on said lower cam.

6. The device of claim 1, wherein each of said plurality of detents of said upper cam and each of said plurality of recesses of said lower cam is constructed with an inclined flank to enable each of said plurality of detents and each of said plurality of recesses to slidingly engage one another.

7. The device of claim 6, wherein said inclined flank has an angle of inclination of between approximately 40 degrees and approximately 50 degrees.

8. The device of claim 1, wherein said support arm is further comprised of two pinholes on said first end, said upper cam is further comprised of an aperture therethrough, and said upper cam locking mechanism is comprised of a dowel disposed substantially through said aperture and said two pinholes.

9. The device of claim 8, wherein said upper cam locking mechanism is further comprised of a plurality of retaining slots disposed on said first end of said support arm and a plurality of inner ears disposed on said inner surface of said upper cam, and said inner ears functionally engaging said retaining slots.

10. The device of claim 1, wherein said upper cam locking mechanism is comprised of welding, an epoxy, a cotter pin, at least one spline, and combinations thereof.

11. The device of claim 1, wherein said taper compensation mechanism is comprised of
said lower cam being constructed of a plurality of lower cam elements, wherein each of said plurality of recesses is further comprised of a first beveled surface; and
each of said plurality of detents of said upper cam further comprised of a second beveled surface, such that each of said second beveled surfaces of said upper cam correspond with said first beveled surfaces of said lower cam, and exert a radial force on each of said plurality of said lower cam elements to maintain a constant engagement between each of said plurality of lower cam elements and said tapered inner surface of said cup of said lower mounting assembly.

12. The device of claim 11, wherein said beveled surface of said lower cam and said beveled surface of said upper cam are each beveled between approximately five degrees and approximately forty degrees.

13. The device of claim 1, wherein said taper compensation mechanism is comprised of:
a straightening piece disposed within said cup and comprised of a vertical inner surface and a tapered outer surface, wherein said tapered outer surface corresponds with said tapered inner surface of said cup;
a straightening piece anti-rotation mechanism; and
a lower cam anti-rotation mechanism.

14. The device of claim 13, wherein said straightening piece anti-rotation mechanism is selected from a group comprised of welding, an epoxy, a cotter pin, a plurality of teeth, a plurality of splines, at least one set screw, a press fit, and combinations thereof.

15. The device of claim 1, wherein said taper compensation mechanism is comprised of a generally cylindrical wedged cap with a beveled upper surface and a lower surface, said wedged cap disposed between said biasing member and said lower cam, wherein said beveled upper surface exerts a radial force on said lower cam.

16. The device of claim 1, wherein said taper compensation mechanism is comprised of machining said cup of said lower mounting assembly so that said inner surface of said cup is substantially perpendicular to said lower surface.

17. The device of claim 1, wherein said lower cam anti-rotation mechanism is selected from a group comprised of: a plurality of guide ribs on said tapered inner surface of said cup and a plurality of corresponding guide slots on said a plurality of guide slots on said tapered inner surface of said cup and a plurality of corresponding guide ribs on said outer surface of said lower cam; and a combination thereof.

18. The device of claim 1, wherein said lower cam anti-rotation mechanism is comprised of said lower cam being constructed of a plurality of lower cam elements with a gap between each of said plurality of lower cam elements, each of said plurality of lower cam element having an outer surface and a first guide slot or a first guide rib on each outer surface of said plurality of lower cam elements, and said inner surface of said cup having a plurality of second guide ribs corresponding with each of said plurality of guide slots and said gaps of said lower cam element or a plurality of second guide slots corresponding with said plurality of first guide ribs of each of said plurality of lower cam elements and a plurality of third guide ribs each corresponding with said plurality of gaps.

19. The device of claim 1, wherein said upper cam is further comprised of a plurality of stops and said lower mounting assembly is comprised of a plurality of corresponding tabs to prevent said upper cam and said support arm from being rotated beyond a threshold point.

20. An assembly comprised of:
a support arm with a first end and a second end;
a mirror head adapted to functionally engage said support arm along said support arm;
a lower mounting assembly adapted to be affixed to a vehicle and to functionally engage said first end of said support arm, wherein said lower mounting assembly is comprised of a cup with a bottom surface and a tapered inner surface, said bottom surface further comprised of an entry hole adapted to receive said support arm, and said tapered inner surface is comprised of a plurality of guide ribs;
an upper mounting assembly, adapted to be affixed to said vehicle and adapted to functionally engage said second end of said support arm; and
a mirror clutch assembly disposed substantially with said cup of said lower mounting assembly and comprised of:
a generally cylindrical upper cam with an upper surface, a lower surface, a inner surface, and an outer surface, wherein said lower surface of said upper cam is comprised of a plurality of detents;
a generally cylindrical lower cam with an upper surface, a lower surface, an inner surface and an outer surface, located below and functionally engaging said upper cam, wherein said lower cam is comprised of a plurality of lower cam elements, a plurality recesses for receiving said plurality of detents of said upper cam, and a plurality of recesses functionally engaging said plurality of guide ribs of said tapered inner surface of said cup, wherein said plurality of lower cam elements each have a space therebetween to compensate for said tapered inner surface of said cup;
a biasing member disposed within said cup of said lower mounting assembly and functionally engaging said lower surface of said lower cam and for exerting a biasing force on said lower cam toward said upper cam;
a taper compensation mechanism to account for said tapered inner surface of said cup of said lower mounting assembly; and
an upper cam locking mechanism for locking said upper cam in position relative to said support arm; and
such that upon exertion of an external force on said device, said support arm and said upper cam axially rotate and said lower cam vertically translates to at least partially absorb said external force and substantially prevents damage to said vehicle and said mirror head.

21. The assembly of claim 20, wherein said support arm, said mirror head, said lower mounting assembly, said upper mounting assembly, said upper cam, said lower cam, and said clutch spring are each made of a material selected from a group comprised of zinc, aluminum, plastic, and combinations thereof.

22. The assembly of claim 20, wherein said biasing member is selected from a group comprised of a clutch spring, a fluid, a hydraulic device, an elastomeric material, a rubber, and combinations thereof.

23. The assembly of claim 20, wherein said mirror clutch assembly is further comprised of a tube washer disposed between said lower surface of said lower cam and said biasing member to provide a flat surface on top of said biasing member to evenly distribute said biasing force on said lower cam.

24. The assembly of claim 20, wherein each of said plurality of detents of said upper cam and each of said plurality of recesses of said lower cam is constructed with an inclined flank to enable each of said plurality of detents and each of said plurality of recesses to slidingly engage one another, said inclined flank having an angle of inclination of between approximately 40 degrees and approximately 50 degrees.

25. The assembly of claim 20, wherein said support arm is further comprised of two pinholes on said first end, said upper cam is further comprised of an aperture therethrough, and said upper cam locking mechanism is comprised of a dowel disposed substantially through said aperture and said two pinholes.

26. The assembly of claim 25, wherein said upper cam locking mechanism is further comprised of a plurality of retaining slots disposed on said first end of said support arm and a plurality of inner ears disposed on said inner surface of said upper cam, and said inner ears functionally engaging said retaining slots.

27. The assembly of claim 20, wherein said upper cam locking mechanism is comprised of welding, an epoxy, a cotter pin, at least one spline, and combinations thereof.

28. The assembly of claim 20, wherein said taper compensation mechanism is comprised of
said lower cam being constructed of a plurality of lower cam elements, wherein each of said plurality of recesses is further comprised of a first beveled surface; and
each of said plurality of detents of said upper cam further comprised of a second beveled surface, such that each of said second beveled surfaces of said upper cam correspond with said first beveled surfaces of said lower cam, and exert a radial force on each of said plurality of said lower cam elements to maintain a constant engagement between each of said plurality of lower cam elements and said tapered inner surface of said cup of said lower mounting assembly, wherein said beveled surface of said lower cam and said beveled surface of said upper cam are each beveled between approximately five degrees and approximately forty degrees.

29. The assembly of claim 20, wherein said taper compensation mechanism is comprised of:
a straightening piece disposed within said cup and comprised of a vertical inner surface and a tapered outer surface, wherein said tapered outer surface corresponds with said tapered inner surface of said cup;
a straightening piece anti-rotation mechanism; and
a lower cam anti-rotation mechanism.

30. The assembly of claim 29, wherein said straightening piece anti-rotation mechanism is selected from a group comprised of welding, an epoxy, a cotter pin, a plurality of teeth, a plurality of splines, at least one set screw, a press fit, and combinations thereof.

31. The assembly of claim 20, wherein said taper compensation mechanism is comprised of a generally cylindrical wedged cap with a beveled upper surface and a lower surface, said wedged cap disposed between said biasing member and said lower cam, wherein said beveled upper surface exerts a radial force on said lower cam.

32. The assembly of claim 20, wherein said taper compensation mechanism is comprised of machining said cup of said lower mounting assembly so that said inner surface of said cup is substantially perpendicular to said lower surface.

33. The assembly of claim 20, wherein said upper cam is further comprised of a plurality of stops and said lower mounting assembly is comprised of a plurality of corresponding tabs to prevent said upper cam and said support arm from being rotated beyond a threshold point.

34. A mirror-operating device comprised of:
a support arm with a first end and a second end, wherein said first end is comprised of two pinholes and two retaining slots;
a mirror head adapted to functionally engage said support arm along said support arm;
a lower mounting assembly adapted to be affixed to a vehicle and to functionally engage said first end of said support arm, wherein said lower mounting assembly is comprised of a cup with a bottom surface and a tapered inner surface, said bottom surface further comprised of an entry hole adapted to receive said support arm, and said tapered inner surface is comprised of a plurality of guide ribs;
an upper mounting assembly, adapted to be affixed to said vehicle and adapted to functionally engage said second end of said support arm; and
a mirror clutch assembly disposed substantially with said cup of said lower mounting assembly and comprised of:
a generally cylindrical upper cam with an upper surface, a lower surface, a inner surface, an outer surface, and an aperture therethrough, wherein said lower surface of said upper cam is comprised of a plurality of detents and said inner surface is comprised of a first ear and a second ear, said first ear and said second ear adapted to fit within said two retaining slots of said first end of said support arm to lock said upper cam in position relative to said support arm;
a dowel disposed within said aperture of said upper cam, wherein said first ear and said second ear fit within said two retaining slots of said first end of said support arm and said dowel lock said upper cam in position relative to said support art;
a generally cylindrical lower cam with an upper surface, a lower surface, an inner surface and an outer surface, located below and functionally engaging said upper cam, wherein said lower cam is comprised of a plurality of lower cam elements, a plurality recesses for receiving said plurality of detents of said upper cam, and a plurality of recesses functionally engaging said plurality of guide ribs of said tapered inner surface of said cup, wherein said plurality of lower cam elements each have a space therebetween to compensate for said tapered inner surface of said cup;
a biasing member disposed within said cup of said lower mounting assembly and functionally engaging said lower surface of said lower cam and for exerting a biasing force on said lower cam toward said upper cam;
such that upon exertion of an external force on said device, said support arm and said upper cam axially rotate and said lower cam vertically translates to at least partially absorb said external force and prevent/minimize damage to said vehicle and said mirror head.

35. The mirror-operating device of claim 34, wherein said support arm, said mirror head, said lower mounting assembly, said upper mounting assembly, said upper cam, said lower cam, and said clutch spring are each made of a material selected from a group comprised of zinc, aluminum, plastic, and combinations thereof.

36. The mirror-operating device of claim 34, wherein said biasing member is selected from a group comprised of a clutch spring, a fluid, a hydraulic device, an elastomeric material, a rubber, and combinations thereof.

37. The mirror-operating device of claim 34, wherein said mirror clutch assembly is further comprised of a tube washer disposed between said lower surface of said lower cam and said biasing member to provide a flat surface on top of said biasing member to evenly distribute said biasing force on said lower cam.

38. The mirror-operating device of claim 34, wherein each of said plurality of detents of said upper cam and each of said plurality of recesses is constructed with an inclined flank to enable each of said plurality of detents and each of said plurality of recesses to slidingly engage one another, said inclined flank having an angle of inclination of between approximately 40 degrees and approximately 50 degrees.

39. The mirror-operating device of claim 34, wherein said upper cam is further comprised of a plurality of stops and said lower mounting assembly is comprised of a plurality of corresponding tabs to prevent said upper cam and said support arm from being rotated beyond a threshold point.

40. A clutch assembly capable of functionally engaging a vehicle mirror support arm and being located within a tapered and generally cylindrical cup, wherein said cup is adapted to receive said support arm, said clutch assembly comprised of:
a generally cylindrical upper cam with an upper surface, a lower surface, a inner surface, and an outer surface, wherein said lower surface of said upper cam is comprised of a plurality of detents;
a generally cylindrical lower cam with an upper surface, a lower surface, an inner surface and an outer surface, located below and functionally engaging said upper cam, wherein said lower cam is further comprised of a plurality recesses for receiving said plurality of detents of said upper cam;
a biasing member functionally engaging said lower surface of said lower cam and for exerting a biasing force on said lower cam toward said upper cam;
an upper cam locking mechanism for locking said upper cam in position relative to said support arm; and
a taper compensation mechanism, to account for said tapered inner surface of said cup;
such that upon exertion of an external force on said support arm, said support arm and said upper cam axially rotate and said lower cam vertically translates to at least partially absorb said external force.

41. The clutch assembly of claim 40, wherein said biasing member is selected from a group comprised of a clutch spring, a fluid, a hydraulic device, an elastomeric material, a rubber, and combinations thereof.

42. The clutch assembly of claim 40, wherein said mirror clutch assembly is further comprised of a tube washer disposed between said lower surface of said lower cam and said biasing member to provide a flat surface on top of said biasing member to evenly distribute said biasing force on said lower cam.

43. The clutch assembly of claim 40, wherein each of said plurality of detents of said upper cam and each of said plurality of recesses of said lower cam is constructed with an inclined flank to enable each of said plurality of detents and each of said plurality of recesses to slidingly engage one another, said inclined flank having an angle of inclination of between approximately 40 degrees and approximately 50 degrees.

44. The clutch assembly of claim 40, wherein said vehicle mirror support arm is further comprised of two pinholes on said first end, said upper cam is further comprised of an aperture therethrough, and said upper cam locking mechanism is comprised of a dowel disposed substantially through said aperture and said two pinholes.

45. The clutch assembly of claim 44, wherein said upper cam locking mechanism is further comprised of a plurality of retaining slots disposed on said first end of said support arm and a plurality of inner ears disposed on said inner surface of said upper cam, and said inner ears functionally engaging said retaining slots.

46. The clutch assembly of claim 40, wherein said upper cam locking mechanism is comprised of welding, an epoxy, a cotter pin, at least one spline, and combinations thereof.

47. The clutch assembly of claim 40, wherein said taper compensation mechanism is comprised of
said lower cam being constructed of a plurality of lower cam elements, wherein each of said plurality of recesses is further comprised of a first beveled surface; and
each of said plurality of detents of said upper cam further comprised of a second beveled surface, such that each of said second beveled surfaces of said upper cam correspond with said first beveled surfaces of said lower cam, and exert a radial force on each of said plurality of said lower cam elements to maintain a constant engagement between each of said plurality of lower cam elements and said tapered inner surface of said cup of said lower mounting assembly, wherein said beveled surface of said lower cam and said beveled surface of said upper cam are each beveled between approximately five degrees and approximately forty degrees.

48. The clutch assembly of claim 40, wherein said taper compensation mechanism is comprised of:
a straightening piece disposed within said cup and comprised of a vertical inner surface and a tapered outer surface, wherein said tapered outer surface corresponds with said tapered inner surface of said cup;
a straightening piece anti-rotation mechanism; and
a lower cam anti-rotation mechanism.

49. The clutch assembly of claim 48, wherein said straightening piece anti-rotation mechanism is selected from a group comprised of welding, an epoxy, a cotter pin, a plurality of teeth, a plurality of splines, at least one set screw, a press fit, and combinations thereof.

50. The clutch assembly of claim 40, wherein said taper compensation mechanism is from a group comprised of: a generally cylindrical wedged cap with a beveled upper surface and a lower surface, said wedged cap disposed between said biasing member and said lower cam, wherein said beveled upper surface exerts a radial force on said lower cam; machining said cup of said lower mounting assembly so that said inner surface of said cup is substantially perpendicular to said lower surface; and a plurality of stops and said lower mounting assembly is comprised of a plurality of corresponding tabs to prevent said upper cam and said support arm from being rotated beyond a threshold point
